(19) United States
(12) Patent Application Publication
(10) Pub. No.: US 2019/0057156 A1
(43) Pub. Date: Feb. 21, 2019

(54) SYSTEMS AND METHODS FOR PROVIDING DYNAMIC HOVERCARDS ASSOCIATED WITH PAGES IN A SOCIAL NETWORKING SYSTEM

(71) Applicant: Facebook, Inc., Menlo Park, CA (US)

(72) Inventors: Meiying Li, Bellevue, WA (US); Bradley Ray Green, Snohomish, WA (US); Jing He, Kirkland, WA (US); Andrew Bangkrasor Johnson, Seattle, WA (US)

(21) Appl. No.: 15/680,556

(22) Filed: Aug. 18, 2017

(51) Int. Cl. G06F 17/30; G06N 99/00

(52) U.S. Cl. CPC G06F 17/30867; G06Q 50/01; G06N 99/005

(57) ABSTRACT

Systems, methods, and non-transitory computer readable media can receive a request to generate a hovercard associated with a page of a social networking system for a user. One or more of textual content items associated with the page, multimedia content items associated with the page, or actions associated with the page can be ranked for the user, based on one or more machine learning models. The hovercard associated with the page can be dynamically generated for the user for display, based on the ranked textual content items, multimedia content items, or actions.

### FIELD OF THE INVENTION

The present technology relates to the field of social networking systems. More particularly, the present technology relates to techniques for providing dynamic hovercards for pages associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. Pages can be dedicated locations provided by the social networking system to reflect the presence of the entities on the social networking system.

### SUMMARY

Various embodiments of the present disclosure can include systems, methods, and non-transitory computer readable media configured to receive a request to generate a hovercard associated with a page of a social networking system for a user. One or more of textual content items associated with the page, multimedia content items associated with the page, or actions associated with the page can be ranked for the user, based on one or more machine learning models. The hovercard associated with the page can be dynamically generated for the user for display, based on the ranked textual content items, multimedia content items, or actions.

In some embodiments, the request to generate the hovercard is generated in response to detection of a hovering action in connection with page information displayed on a particular surface.

In certain embodiments, the ranking includes: training a machine learning model to rank textual content items associated with pages; and ranking the textual content items associated with the page based on the trained machine learning model

In an embodiment, the ranking includes: training a machine learning model to rank multimedia content items associated with pages; and ranking the multimedia content items associated with the page based on the trained machine learning model.

In some embodiments, the ranking includes: training a machine learning model to rank actions associated with pages; and ranking the actions associated with the page based on the trained machine learning model.

In certain embodiments, the ranking includes: training a machine learning model to rank pairs of textual content items and multimedia content items associated with pages; and ranking pairs of the textual content items associated with the page and the multimedia content items associated with the page based on the trained machine learning model.

In an embodiment, the hovercard includes a page header, one or more ranked textual content items associated with the page, one or more ranked multimedia content items associated with the page, and one or more ranked actions associated with the page.

In some embodiments, the ranking is based on a likelihood of the user engaging with an action to be included in the hovercard.

In certain embodiments, the ranking is based on one or more of: display features, content features, viewer intent features, or admin intent features.

In an embodiment, the textual content items associated with the page include one or more of: a page description, a link, a post, a review, or a social context; the multimedia content items associated with the page include one or more of: a photo, a video, or a map preview; and the actions associated with the page include one or more of: like, follow, save, share, message, or a call-to-action (CTA).

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example dynamic hovercard module configured to provide dynamic hovercards associated with pages, according to an embodiment of the present disclosure.

FIG. 2 illustrates an example hovercard ranking module configured to rank content associated with dynamic hovercards, according to an embodiment of the present disclosure.

FIGS. 3A-3D illustrate example user interfaces for providing dynamic hovercards associated with pages, according to an embodiment of the present disclosure.

FIG. 4 illustrates an example first method for providing dynamic hovercards associated with pages, according to an embodiment of the present disclosure.

FIG. 5 illustrates an example second method for providing dynamic hovercards associated with pages, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Dynamic Hovercards Associated With Pages in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed of a user.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system. Under conventional approaches specifically arising in the realm of computer technology, information relating to pages may appear in various user interfaces associated with a social networking system. For example, a suggested page for a user may appear in a feed (e.g., newsfeed) of the user or in a messaging application. However, conventional approaches may provide information relating to a page without providing additional content or details that can help increase a user's engagement with the page.

An improved approach rooted in computer technology can overcome the foregoing and other disadvantages associated with conventional approaches specifically arising in the realm of computer technology. Based on computer technology, the disclosed technology can provide dynamic hovercards for pages. Information relating to pages can be provided on various surfaces associated with a social networking system. If hovering is detected over information associated with a page presented on a surface, such as the name of the page, a hovercard for the page can be dynamically generated and provided for display on the surface. Content of a hovercard can vary across surfaces. A hovercard can provide a preview for a page that can be helpful to a user in determining whether to engage with the page, for example, by viewing the page. In some embodiments, a hovercard can include a page header, textual content, multimedia content, and one or more actions that can be taken for a page. Textual content, multimedia content, and an order of actions for a hovercard can be determined based on machine learning techniques. One or more machine learning models can be trained to rank textual content, multimedia content, and actions, for example, based on a likelihood of a user selecting an action. A hovercard can be generated based on the ranked textual content, multimedia content, and actions. In this manner, the disclosed technology can provide dynamic content associated with a page that can increase engagement of a user with the page. Details relating to the disclosed technology are provided below.

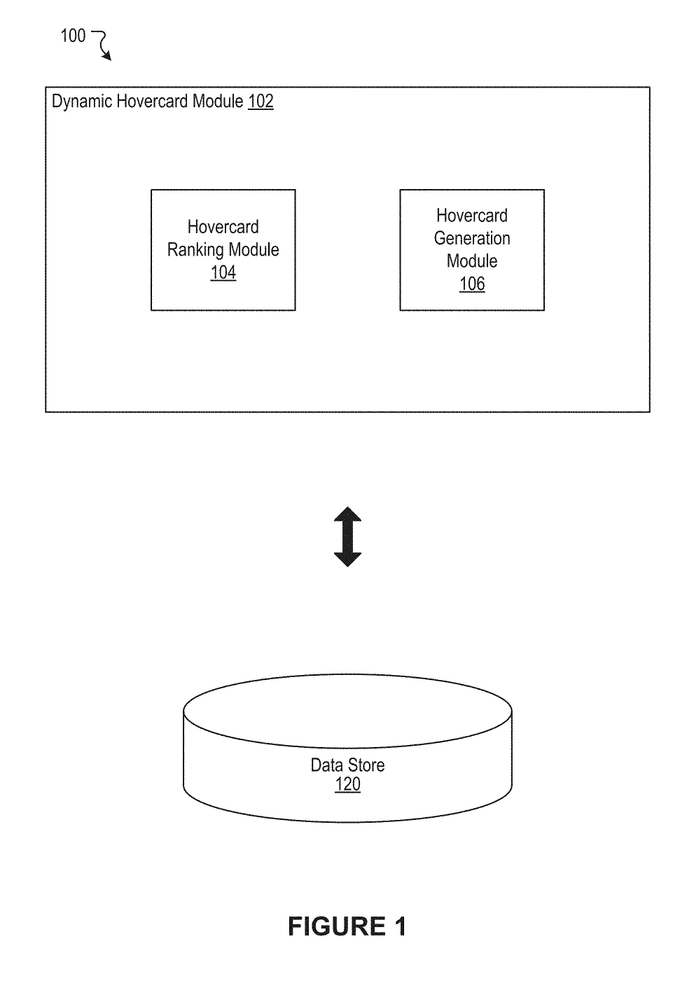

FIG. 1 illustrates an example system 100 including an example dynamic hovercard module 102 configured to provide dynamic hovercards associated with pages, according to an embodiment of the present disclosure. The dynamic hovercard module 102 can include a hovercard ranking module 104 and a hovercard generation module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the dynamic hovercard module 102 can be implemented in any suitable combinations. While the disclosed technology is described in connection with hovercards for pages associated with a social networking system for illustrative purposes, the disclosed technology can apply to any other type of system and/or content.

In some embodiments, a hovercard for a page can include a page header, textual content from the page, multimedia content from the page, and one or more actions that can be taken in connection with the page. The page header can include a profile photo that represents a page, a name or a short name for a page, and social context. For example, the short name can be a name that can be used in place an address or uniform resource locator (URL) of a page. In some embodiments, social context can indicate activities of users or activities of a user's connections relating to a page and/or particular content. There can be different types of textual content. Examples of textual content can include links, reviews, posts, a page description, social context, etc. There can be different types of multimedia content. Examples of multimedia content can include photos, videos, map previews, etc. Examples of actions can include like, follow, save, share, message, a call-to-action (CTA), etc. Actions can be presented as user interface (UI) elements, such as buttons, icons, links, etc. In some instances, UI elements for actions can indicate status information, such as whether a user has already taken the actions. For example, if an action is liking a page and a user has previously liked the page, a button for liking the page can indicate that the page has been liked by the user.

Hovercards can be provided on one or more surfaces. A surface can indicate any user interface or any portion of a user interface through which a hovercard can be provided. A surface can also be referred to as a “platform.” In some embodiments, a surface can be determined or defined based on one or more of the following: a website, a webpage, a particular section of a webpage, an application, a particular page of an application, a particular section of a page of an application, an operating system (OS), a platform (e.g., mobile, desktop, etc.), a type of device, etc. In connection with a social networking system, examples of surfaces can include a feed of a user, a search, a timeline of a page, a profile of a user, etc. Many variations are possible.

A hovercard can be provided in response to a trigger. In some embodiments, the trigger can include detection of hovering over information associated with a page (“page information”) that appears on a surface. Examples of page information can include the name of a page or a preview of a page. A surface can be provided on a computing device of a user. A user may hover over page information, for example, with a mouse or a touch gesture. A request for a hovercard can be generated in response to detection of a hovering action over page information on a surface and can be sent to a server associated with the social networking system. For example, the server can include the dynamic hovercard module 102. The server can dynamically generate a hovercard and can send the generated hovercard to the computing device of the user. In certain embodiments, hovercards may be generated prior to or without a trigger. For example, when the user requests content from the server including page information for a page, a hovercard can be generated for the user and sent to the computing device of the user with the requested content and stored on the computing device of the user. Then, the stored hovercard can be provided to the user in response to the trigger.

The hovercard ranking module 104 can rank content associated with hovercards. For example, one or more machine learning models can be trained to rank textual content, multimedia content, and actions available for a page. Textual content, multimedia content, and actions can be ranked to increase a likelihood of selection by a user with an action presented on a hovercard. Functionality of the hovercard ranking module 104 is described in more detail herein.

The hovercard generation module 106 can generate hovercards based on ranked content associated with the hovercards. Textual content, multimedia content, and actions available on a page can be ranked, for example, by the hovercard ranking module 104. For example, top ranked textual content and top ranked multimedia content can be included in a hovercard as textual content and multimedia content. In addition, some or all of actions available on a page can be included in a hovercard in an order of ranking. The hovercard generation module 106 can generate a hovercard in an appropriate format for a selected surface. In some embodiments, a hovercard can have the same appearance across surfaces. In other embodiments, a hovercard can have a different appearance depending on a surface on which the hovercard is presented. For instance, a size and a layout of a hovercard can depend on a surface. The layout can indicate a visual arrangement of textual content, multimedia content, and actions of a hovercard. As an example, a hovercard to be provided in a feed of a user may be generated in a format that is suitable for presentation in the feed. As another example, a hovercard to be provided in a messaging application may be generated in a format that is suitable for presentation in the messaging application. For instance, a format for a particular surface can specify the size and/or the layout of a hovercard for the particular surface. All examples herein are provided for illustrative purposes, and there can be many variations and other possibilities.

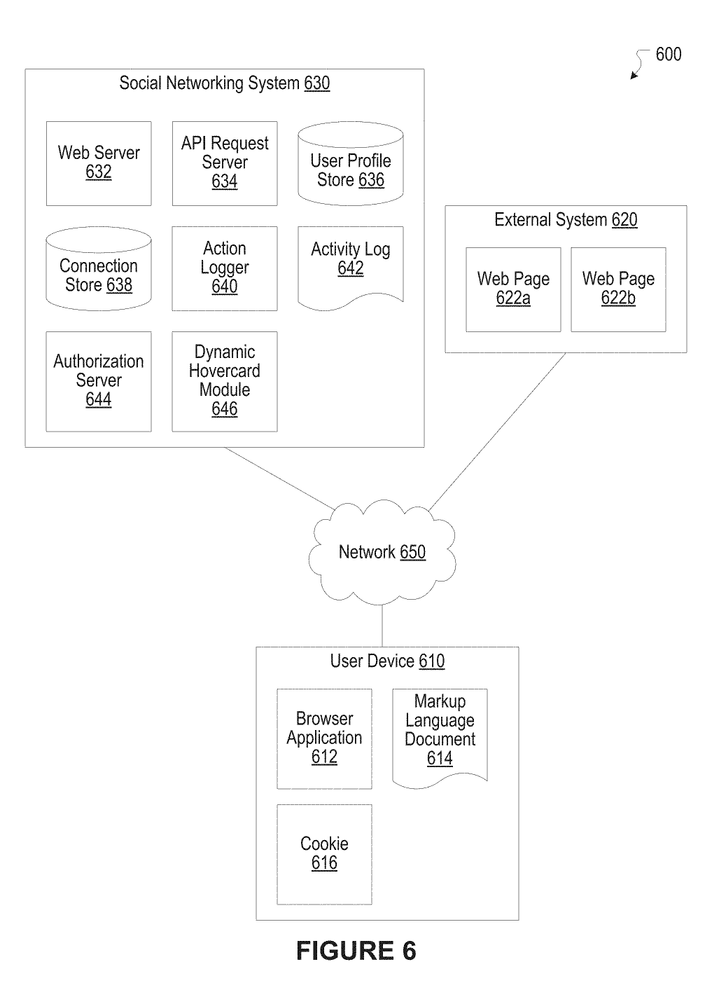

In some embodiments, the dynamic hovercard module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the dynamic hovercard module 102 can be, in part or in whole, implemented as software running on one or more computing devices or systems, such as on a server system or a client computing device. In some instances, the dynamic hovercard module 102 can be, in part or in whole, implemented within or configured to operate in conjunction or be integrated with a social networking system (or service), such as a social networking system 630 of FIG. 6. Likewise, in some instances, the dynamic hovercard module 102 can be, in part or in whole, implemented within or configured to operate in conjunction or be integrated with a client computing device, such as the user device 610 of FIG. 6. For example, the dynamic hovercard module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the dynamic hovercard module 102. The data maintained by the data store 120 can include, for example, information relating to pages, surfaces, dynamic hovercards, textual content, multimedia content, actions, machine learning models, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the dynamic hovercard module 102 can be configured to communicate and/or operate with the data store 120. In some embodiments, the data store 120 can be a data store within a client computing device. In some embodiments, the data store 120 can be a data store of a server system in communication with the client computing device.

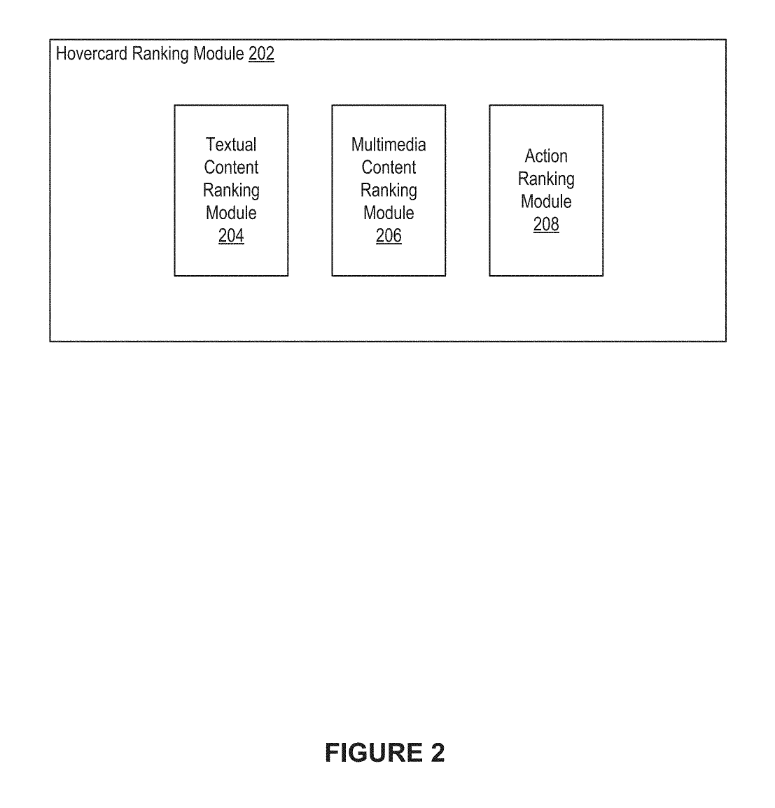

FIG. 2 illustrates an example hovercard ranking module 202 configured to rank content associated with dynamic hovercards, according to an embodiment of the present disclosure. In some embodiments, the hovercard ranking module 104 of FIG. 1 can be implemented with the example hovercard ranking module 202. As shown in the example of FIG. 2, the example hovercard ranking module 202 can include a textual content ranking module 204, a multimedia content ranking module 206, and an action ranking module 208.

One or more machine learning models can be trained to rank textual content, multimedia content, and actions available for a page for inclusion in a hovercard for a particular user. Training data for training the one or more machine learning models can include various features. For example, features can be selected from display features, content features, viewer intent features, and admin (administrator) intent features. Display features can relate to elements or components of hovercards other than textual content, multimedia content, and actions. For example, display features can relate to other visual aspects of hovercards. Content features can relate to content of hovercards, such as textual content and multimedia content. Examples of content features can include language, informativeness, quality, topics, etc. The language can indicate a language associated with a textual content item or a multimedia content item. The informativeness of a textual content item can indicate whether a textual content item, such as a review, or a multimedia content item is informative. The quality of a textual content item can indicate whether a textual content item includes errors, such as misspellings. The quality of a multimedia content item can indicate whether a multimedia content item, such as a photo or a video, is high quality. The topics can relate to one or more topics associated with a textual content item or a multimedia content item. Viewer intent features can relate to possible intent of users who view or are to view hovercards. Viewer intent features can include features associated with surfaces, such as a surface on which a hovercard is provided. A surface can relate to possible intent of viewing users since what viewing users want to accomplish or expect to occur can vary depending on a surface on which a hovercard is provided. Viewer intent features can also include features associated with engagement history of viewing users, such a viewing user's interaction with pages and hovercards. For instance, viewer intent features can indicate what a viewing user previously selected on pages, what a viewing user previously selected at particular times or during particular time windows (e.g., on pages), what a viewing user previously selected for a page category, what pages a viewing user likes, recent or last content a viewing user looked at (e.g., on pages), what a viewing user previously selected in a social networking application, which hovercards a viewing user previously interacted with, what a viewing user previously selected in hovercards, etc. Admin intent features can relate to possible intent of administrators associated with pages. For instance, admin intent features can indicate a specified preference for types of actions specified by an admin, actions an admin is interested in, what type of content an admin produces, etc. In some embodiments, activities of an administrator of a page can be modeled, and it can be determined which actions are most likely to be selected or performed by an administrator of a page based on the activity model. For example, actions an administrator is interested in can be determined based the activity model.

The textual content ranking module 204 can rank textual content available on a page. There can be one or more textual content items associated with a page, such as links, reviews, posts, etc. The textual content ranking module 204 can train a machine learning model to rank textual content items available on a page based on a likelihood of a user engaging with an action included in a hovercard. A user can engage with an action included in a hovercard by selecting the action. For instance, a user can select an action, for example, by a click, a touch gesture, etc. The machine learning model can be trained based on training data (e.g., labeled data) that includes textual content items for hovercards and actions presented on hovercards with which users have engaged. The training data can include various features. For example, features can be selected from display features, content features, viewer intent features, and admin intent features, as described as above, as appropriate. Weights associated with various features used to train the machine learning model can be determined. The textual content ranking module 204 can retrain the machine learning model based on new or updated training data.

The textual content ranking module 204 can apply the trained machine learning model to rank textual content items available on a page to include in a hovercard for a particular user. For example, textual content items and actions of a page can be provided to the trained machine learning model to obtain a ranking of the textual content items. The trained machine learning model can determine a likelihood of a user engaging with an action of a hovercard if a particular textual content item is included in the hovercard. For example, the trained machine learning model can determine a score indicative of a likelihood of a user engaging with the action. Textual content items available on a page can be ranked based on respective scores for the textual content items. One or more top ranked textual content item can be selected for inclusion in the hovercard. For example, a number of textual content items included can be determined based on available slots or spaces in the hovercard.

In a manner similar to the textual content ranking module 204, the multimedia content ranking module 206 can rank multimedia content available on a page. There can be one or more multimedia content items associated with a page, such as photos, videos, and map previews. The multimedia content ranking module 206 can train a machine learning model to rank multimedia content items available on a page based on a likelihood of a user engaging with an action included in a hovercard. The machine learning model can be trained based on training data (e.g., labeled data) that includes multimedia content items for hovercards and actions presented on hovercards with which users have engaged. The training data can include various features. For example, features can be selected from display features, content features, viewer intent features, and admin intent features, as described as above, as appropriate. Weights associated with various features used to train the machine learning model can be determined. The multimedia content ranking module 206 can retrain the machine learning model based on new or updated training data.

The multimedia content ranking module 206 can apply the trained machine learning model to rank multimedia content items available on a page to include in a hovercard for a particular user. For example, multimedia content items and actions of a page can be provided to the trained machine learning model to obtain a ranking of the multimedia content items. The trained machine learning model can determine a likelihood of a user engaging with an action of a hovercard if a particular multimedia content item is included in the hovercard. For example, the trained machine learning model can determine a score indicative of a likelihood of a user engaging with the action. Multimedia content items available on a page can be ranked based on respective scores for the multimedia content items. One or more top ranked multimedia content item can be selected for inclusion in the hovercard. For example, a number of multimedia content items included can be determined based on available slots or spaces in the hovercard.

In certain embodiments, not all actions available on a page may be included in a hovercard for the page. For instance, a page may have more actions than available slots or spaces in a hovercard. In these embodiments, actions available on a page may be ranked prior to ranking textual content items and/or multimedia content items in order to determine which actions should be included in a hovercard of the page. For example, actions available on a page can be ranked first by the action ranking module 208 as described below. Then, textual content items and multimedia content items of a page can be ranked based on the determined actions to be included in a hovercard of the page. For example, the actions that are to be included in the hovercard can be provided to the trained machine learning model for ranking textual content items to obtain a ranking of the textual content items of the page, and to the trained machine learning model for ranking multimedia content items to obtain a ranking of the multimedia content items of the page.

In some embodiments, textual content items and multimedia content items of a page can be ranked as a pair, instead of being ranked separately. For example, if three textual content items are available on a page and two multimedia content items are available on the page, all possible combinations (e.g., six combinations) of textual content items and multimedia content items can be ranked. All possible combinations of textual content item and multimedia content item pairs can be ranked based on a likelihood of a user engaging with an action included in a hovercard. In these embodiments, one machine learning model can be trained to rank pairs, with each pair including a textual content item and a multimedia content item. For example, a machine learning model can be trained based on training data (e.g., labeled data) that includes pairs of textual content items and multimedia content items, and actions presented on hovercards with which users have engaged. Similar to machine learning models explained above, features included in the training data can be selected from display features, content features, viewer intent features, and admin intent features, as described as above, as appropriate. The trained machine learning model can be applied to rank textual content item and multimedia content item pairs available on a page to include in a hovercard for a user. The trained machine learning model can determine a likelihood of a user engaging with an action of a hovercard if a particular textual content item and multimedia content item pair is included in the hovercard. One or more top ranked textual content item and multimedia content item pairs can be selected for inclusion in the hovercard.

The action ranking module 208 can rank one or more actions available on a page. There can be one or more actions associated with a page, such as like, follow, save, share, a CTA, etc. In addition, there can be one or more CTAs associated with a page. The action ranking module 208 can train a machine learning model to rank actions available on a page based on a likelihood of a user engaging with the actions included in a hovercard. The machine learning model can be trained based on training data including actions for hovercards and corresponding ordering of the actions. The training data can include various features. For example, features can be selected from display features, content features, viewer intent features, and admin intent features, as described as above, as appropriate. Weights associated with various features used to train the machine learning model can be determined. The action ranking module 208 can retrain the machine learning model based on new or updated training data.

The action ranking module 208 can apply the trained machine learning model to rank actions available on a page to include in a hovercard for a particular user. For example, actions available on a page can be provided to the trained machine learning model to obtain a ranking of the actions. The trained machine learning model can determine a likelihood of a user engaging with an action of a hovercard if the action is included in the hovercard. For example, the trained machine learning model can determine a score indicative of a likelihood of a user engaging with the action. Actions available on a page can be ranked based on respective scores for the actions. In some embodiments, the trained machine learning model can output a ranking of an action, instead of a score. All or some of the actions available on a page can be included in the hovercard in the order of the ranking. For example, top ranked actions can be included in the hovercard in the order of the ranking. As another example, all actions can be included in the hovercard in the order of the ranking. One or more machine learning models discussed in connection with the dynamic hovercard module 102 and its components, such as the hovercard ranking module 202, can be implemented separately or in combination, for example, as a single machine learning model, as multiple machine learning models, as one or more staged machine learning models, as one or more combined machine learning models, etc.

In some embodiments, one or more content items selected to be included in a hovercard may be associated with different types. In these embodiments, content items to be included in the hovercard can be adjusted such that the content items are associated with the same type. As an example, in connection with textual content items, top two ranked textual content items selected to be included in the hovercard are a review and a link. Since a review and a link are of different types, the link can be replaced with another review that is lower in ranking, or vice versa. As another example, in connection with multimedia content items, top two ranked multimedia content items selected to be included in the hovercard are a photo and a video. Since a photo and a video are of different types, the video can be replaced with another photo that is lower in ranking, or vice versa. All examples herein are provided for illustrative purposes, and there can be many variations and other possibilities.

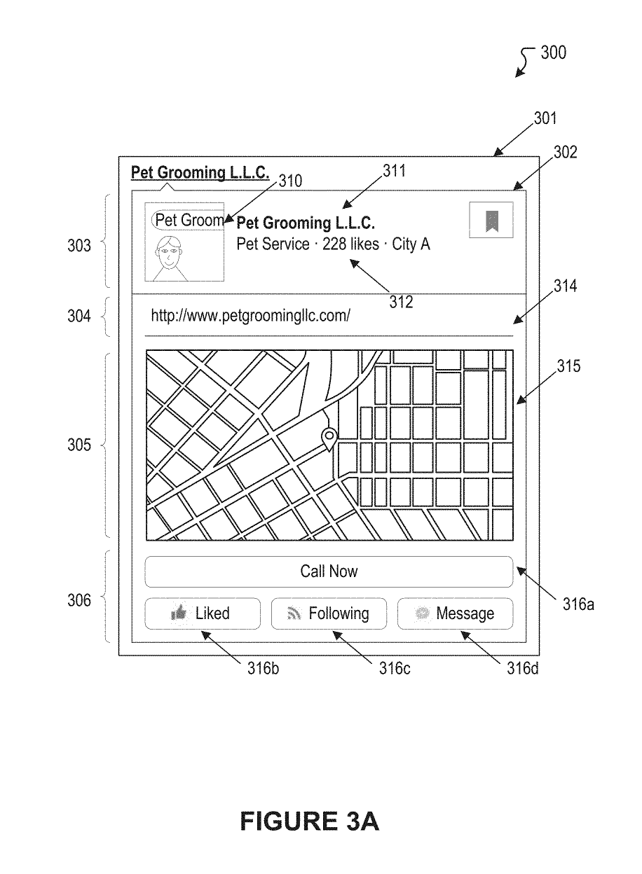

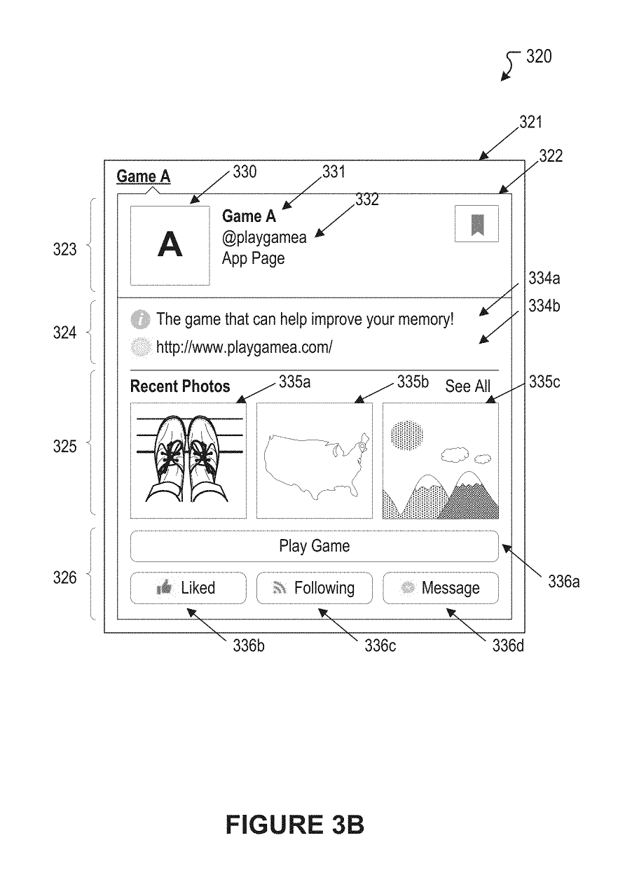

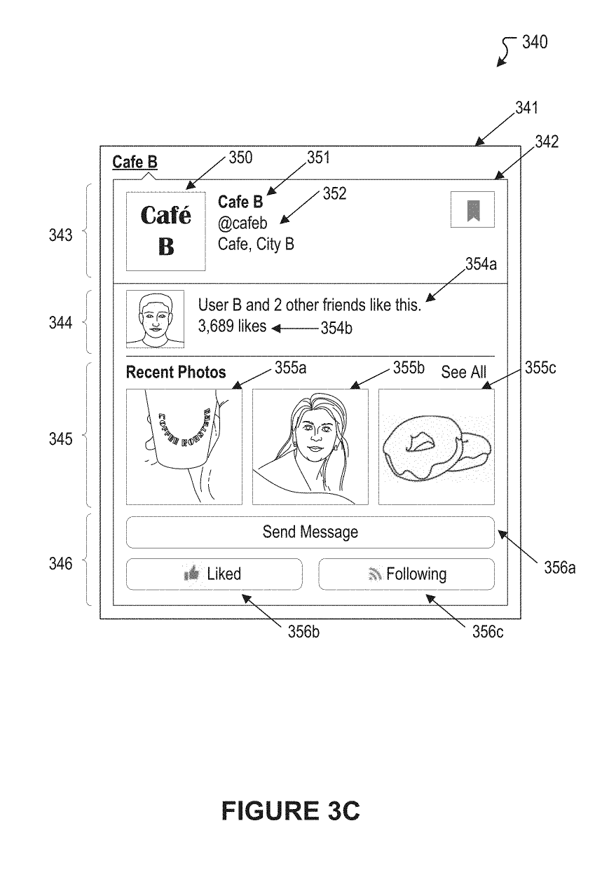

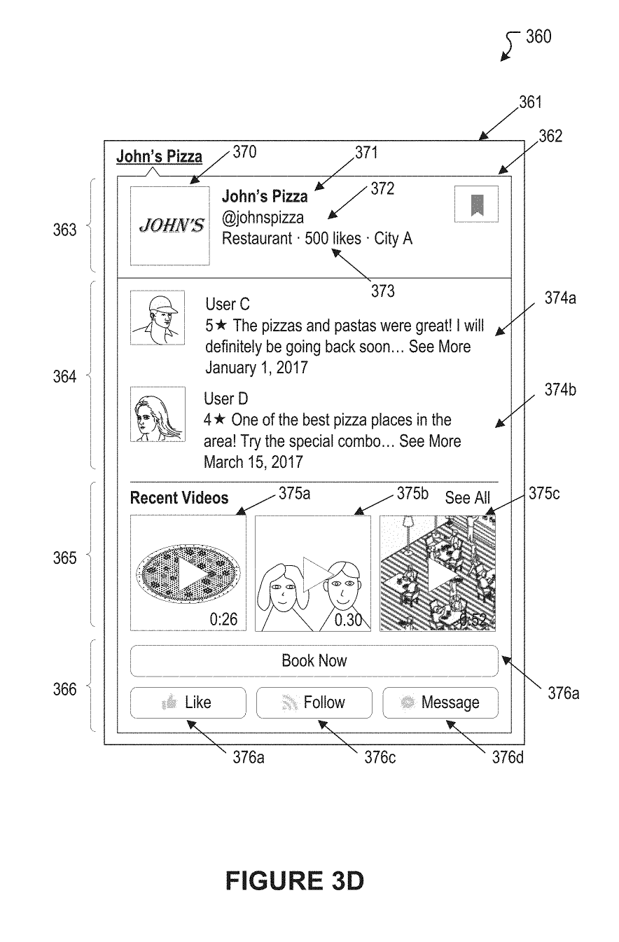

FIGS. 3A-3D illustrate example user interfaces 300, 320, 340, and 360 for providing dynamic hovercards associated with pages, according to an embodiment of the present disclosure. FIGS. 3A-3D illustrate different textual content, multimedia content, and actions that can be included in a hovercard. In FIGS. 3A-3D, the user interface 300, 320, 340, 360 illustrates, respectively, a surface 301, 321, 341, 361 displaying, respectively, a hovercard 302, 322, 342, 362 for a page. The hovercard 302, 322, 342, 362 can include, respectively, a page header section 303, 323, 343, 363, a textual content section 304, 324, 344, 364, a multimedia content section 305, 325, 345, 365, and an action section 306, 326, 346, 366. The textual content section 304, 324, 344, 364 can include one or more top ranked textual content items associated with the page. The multimedia content section 305, 325, 345, 365 can include one or more top ranked multimedia content items associated with the page. The action section 306, 326, 346, 366 can include one or more ranked actions represented as UI elements, such as buttons. A user can select a corresponding UI element in order to select or engage with an action. The hovercard 302, 322, 342, 362 can be dynamically generated and displayed on the surface 301, 321, 341, 361 in response to detection of hovering over page information associated with the page. For example, the hovercard 302, 322, 342, 362 can be generated by the dynamic hovercard module 102, as described above.

In FIG. 3A, the hovercard 302 is provided for a page associated with a pet service company. The page header section 303 includes a name 311 of the page, a profile photo 310 of the page, and social context 312. For example, the social context 312 indicates a number of users who like the page. The page header section 303 can also include a cover photo of the page (not shown). The textual content section 304 includes a link 314 to a website associated with the page as a textual content item. For example, the link 314 can be a top ranked textual content item associated with the page. The multimedia content section 305 includes a map preview 315 as a multimedia content item. For example, the map preview 315 can be a top ranked multimedia content item associated with the page. The action section 306 includes buttons 316a, 316b, 316c, 316d for actions associated with the page. The action section 306 displays the buttons 316a, 316b, 316c, 316d in the order of ranking. In some embodiments, the first ranked button 316a can be provided in the form of a CTA. The link 314 and the map preview 315 can each be selected based on a likelihood of a user engaging with one of the actions represented by the buttons 316a, 316b, 316c, 316d.

In FIGS. 3B-3D, the user interfaces 320, 340, and 360 can be similar to the user interface 320 in FIG. 3A. In FIG. 3B, the hovercard 322 is provided for a page associated with a game. The page header section 323 includes a name 331 of the page, a short name 332 of the page, and a profile photo 330 of the page. The textual content section 324 includes a page description 334a and a link 334b to a website associated with the page as textual content items. The multimedia content section 325 includes photos 335a, 335b, 335c as multimedia content items. The action section 326 includes buttons 336a, 336b, 336c, 336d, for example, in the order of ranking.

In FIG. 3C, the hovercard 342 is provided for a page associated with a cafe. The page header section 343 includes a name 351 of the page, a short name 352 of the page, and a profile photo 350 of the page. The textual content section 344 includes social context 354a, which indicates that certain connections (e.g., friends) of a user like the page. The textual content section 344 also includes social context 354b, which indicates a number of users who like the page. The multimedia content section 345 includes photos 355a, 355b, 355c as multimedia content items. The action section 346 includes buttons 356a, 356b, 356c, for example, in the order of ranking.

In FIG. 3D, the hovercard 362 is provided for a page associated with a restaurant. The page header section 363 includes a name 371 of the page, a short name 372 of the page, a profile photo 370 of the page, and social context 373 (e.g., a number of likes). The textual content section 364 includes reviews 374a, 374b. The multimedia content section 365 includes videos 375a, 375b, 375c as multimedia content items. The action section 366 includes buttons 376a, 376b, 376c, 376d, for example, in the order of ranking. All examples herein are provided for illustrative purposes, and there can be many variations and other possibilities.

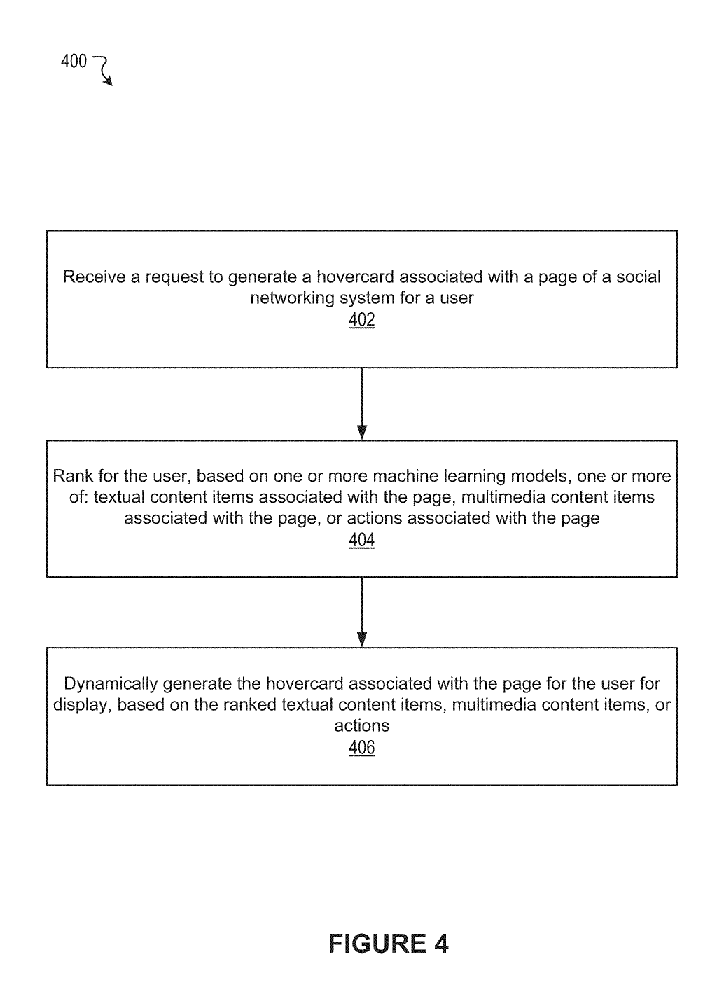

FIG. 4 illustrates an example first method 400 for providing dynamic hovercards associated with pages, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can receive a request to generate a hovercard associated with a page of a social networking system for a user. At block 404, the example method 400 can rank for the user, based on one or more machine learning models, one or more of: textual content items associated with the page, multimedia content items associated with the page, or actions associated with the page. At block 406, the example method 400 can dynamically generate the hovercard associated with the page for the user for display, based on the ranked textual content items, multimedia content items, or actions. Other suitable techniques that incorporate various features and embodiments of the present disclosure are possible.

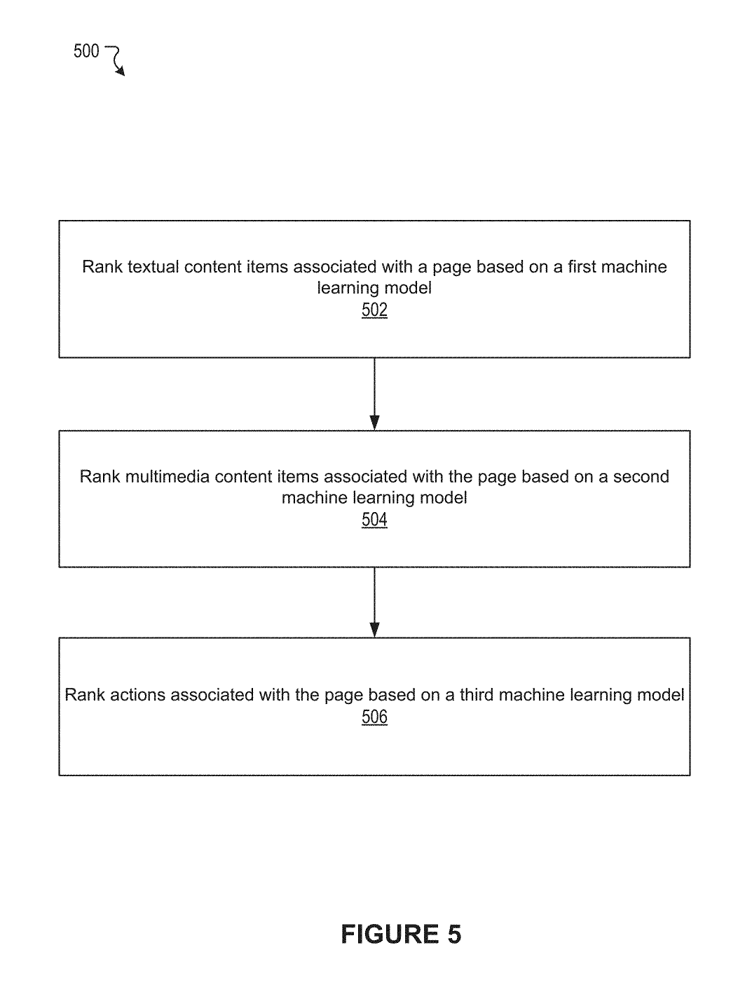

FIG. 5 illustrates an example second method 500 for providing dynamic hovercards associated with pages, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can rank textual content items associated with a page based on a first machine learning model. The textual content items can be similar to the textual content items explained in connection with FIG. 4. The page can be similar to the page explained in connection with FIG. 4. At block 504, the example method 500 can rank multimedia content items associated with the page based on a second machine learning model. The multimedia content items can be similar to the multimedia content items explained in connection with FIG. 4. At block 506, the example method 500 can rank actions associated with the page based on a third machine learning model. The actions can be similar to the actions explained in connection with FIG. 4. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a dynamic hovercard module 646. The dynamic hovercard module 646 can be implemented with the dynamic hovercard module 102, as discussed in more detail herein. In some embodiments, one or more functionalities of the dynamic hovercard module 646 can be implemented in the user device 610.

### Hardware Implementation

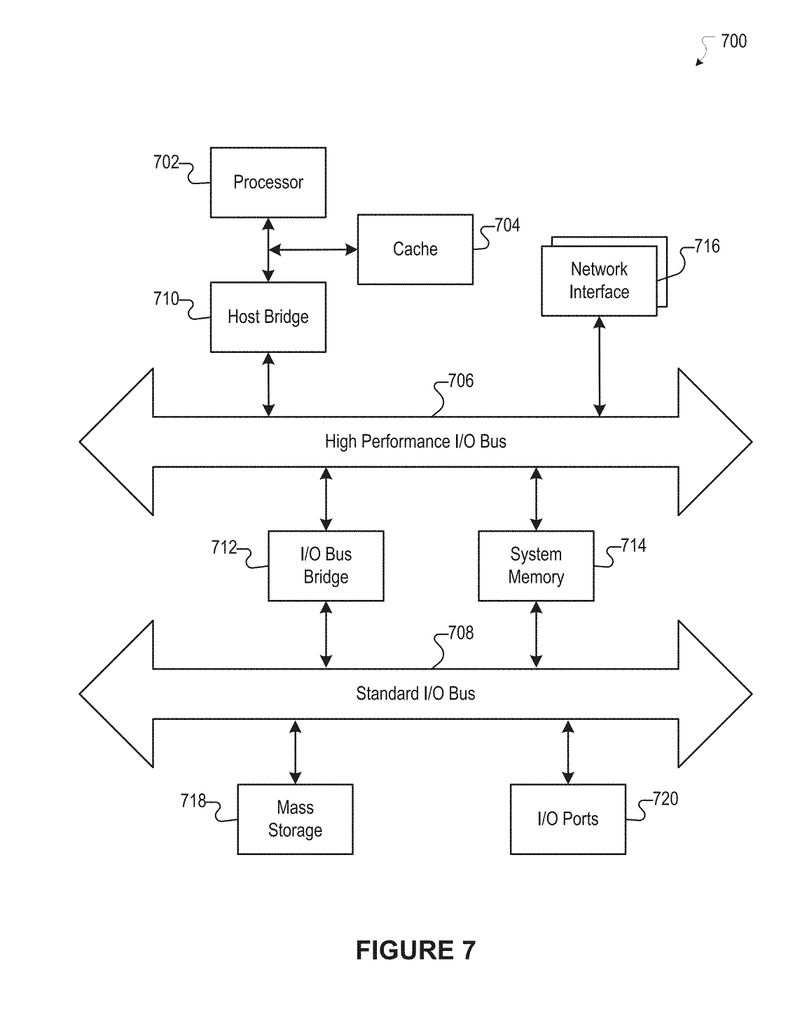

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a request to generate a hovercard associated with a page of a social networking system for a user;
ranking, by the computing system, for the user, based on one or more machine learning models, one or more of: textual content items associated with the page, multimedia content items associated with the page, or actions associated with the page; and
dynamically generating, by the computing system, the hovercard associated with the page for the user for display, based on the ranked textual content items, multimedia content items, or actions.

2. The computer-implemented method of claim 1, wherein the request to generate the hovercard is generated in response to detection of a hovering action in connection with page information displayed on a particular surface.

3. The computer-implemented method of claim 1, wherein the ranking includes:
training a machine learning model to rank textual content items associated with pages; and
ranking the textual content items associated with the page based on the trained machine learning model.

4. The computer-implemented method of claim 1, wherein the ranking includes:
training a machine learning model to rank multimedia content items associated with pages; and
ranking the multimedia content items associated with the page based on the trained machine learning model.

5. The computer-implemented method of claim 1, wherein the ranking includes:
training a machine learning model to rank actions associated with pages; and
ranking the actions associated with the page based on the trained machine learning model.

6. The computer-implemented method of claim 1, wherein the ranking includes:
training a machine learning model to rank pairs of textual content items and multimedia content items associated with pages; and
ranking pairs of the textual content items associated with the page and the multimedia content items associated with the page based on the trained machine learning model.

7. The computer-implemented method of claim 1, wherein the hovercard includes a page header, one or more ranked textual content items associated with the page, one or more ranked multimedia content items associated with the page, and one or more ranked actions associated with the page.

8. The computer-implemented method of claim 1, wherein the ranking is based on a likelihood of the user engaging with an action to be included in the hovercard.

9. The computer-implemented method of claim 1, wherein the ranking is based on one or more of: display features, content features, viewer intent features, or admin intent features.

10. The computer-implemented method of claim 1, wherein
the textual content items associated with the page include one or more of: a page description, a link, a post, a review, or a social context;
the multimedia content items associated with the page include one or more of: a photo, a video, or a map preview; and
the actions associated with the page include one or more of: like, follow, save, share, message, or a call-to-action (CTA).

11. A system comprising:
at least one hardware processor; and
a memory storing instructions that, when executed by the at least one processor, cause the system to perform:
receiving a request to generate a hovercard associated with a page of a social networking system for a user;
ranking for the user, based on one or more machine learning models, one or more of: textual content items associated with the page, multimedia content items associated with the page, or actions associated with the page; and
dynamically generating the hovercard associated with the page for the user for display, based on the ranked textual content items, multimedia content items, or actions.

12. The system of claim 11, wherein the ranking includes:
training a machine learning model to rank textual content items associated with pages; and
ranking the textual content items associated with the page based on the trained machine learning model.

13. The system of claim 11, wherein the ranking includes:
training a machine learning model to rank multimedia content items associated with pages; and
ranking the multimedia content items associated with the page based on the trained machine learning model.

14. The system of claim 11, wherein the ranking includes:
training a machine learning model to rank actions associated with pages; and
ranking the actions associated with the page based on the trained machine learning model.

15. The system of claim 11, wherein the hovercard includes a page header, one or more ranked textual content items associated with the page, one or more ranked multimedia content items associated with the page, and one or more ranked actions associated with the page.

16. A non-transitory computer readable medium including instructions that, when executed by at least one hardware processor of a computing system, cause the computing system to perform a method comprising:
receiving a request to generate a hovercard associated with a page of a social networking system for a user;
ranking for the user, based on one or more machine learning models, one or more of: textual content items associated with the page, multimedia content items associated with the page, or actions associated with the page; and
dynamically generating the hovercard associated with the page for the user for display, based on the ranked textual content items, multimedia content items, or actions.

17. The non-transitory computer readable medium of claim 16, wherein the ranking includes:
training a machine learning model to rank textual content items associated with pages; and
ranking the textual content items associated with the page based on the trained machine learning model.

18. The non-transitory computer readable medium of claim 16, wherein the ranking includes:
training a machine learning model to rank multimedia content items associated with pages; and
ranking the multimedia content items associated with the page based on the trained machine learning model.

19. The non-transitory computer readable medium of claim 16, wherein the ranking includes:
training a machine learning model to rank actions associated with pages; and
ranking the actions associated with the page based on the trained machine learning model.

20. The non-transitory computer readable medium of claim 16, wherein the hovercard includes a page header, one or more ranked textual content items associated with the page, one or more ranked multimedia content items associated with the page, and one or more ranked actions associated with the page.
